(19) United States
(12) Patent Application Publication
(10) Pub. No.: US 2006/0011769 A1
(43) Pub. Date: Jan. 19, 2006

(54) Arrangement for changing a winding drum

(76) Inventors: Peter Skuk, Nidderau (DE); Karl-Heinrich Wenk, Bad Nauheim (DE); Richard Klaus, Erfurt (DE)

Correspondence Address: FULBRIGHT & JAWORSKI, LLP, 666 FIFTH AVE, NEW YORK, NY, 10103-3198, US

(21) Appl. No.: 11/006,516

(22) Filed: Dec. 7, 2004

(30) Foreign Application Priority Data
Jul. 16, 2004 (EP) 04 016 804.9

(51) Int. Cl. B65H 19/12; B65H 19/30; B05C 5/04

(52) U.S. Cl. 242/533; 242/538.2; 118/325

(57) ABSTRACT

The invention relates to an arrangement for changing a winding drum in a take-up or feed-out chamber of a coating installation for web-form material. One such arrangement can be provided on both sides of a coating chamber, the one arrangement serving as a take-up drum and the other arrangement as a feed-out drum. The arrangement comprises two tracks for receiving end bearings of a winding drum, the tracks being comprised of two parts, of which the one part is stationary and the other is pivotable. The arrangement is located in a housing with a door. If the winding drum is to be replaced, the door is opened and the pivotable parts of the tracks are folded outwardly such that they project from the housing. Onto the projecting track parts a winding drum can now be placed, it can subsequently be slid inwardly and be arrested.

The invention relates to an arrangement according to the preamble of patent claim 1.

In web coating installations a synthetic film drum is unwound, the wound-off film is coated and the coated film is wound up again.

When the film drum has been fed out completely, it must be replaced by a new and full film drum. On the other hand, the completely wound-up film must also be removed and be replaced by an empty winding core.

In order to be able to guide these web-form synthetic films past a coating site, for example past a sputtering cathode or a vaporizer, feed-out and take-up arrangements for these films are necessary. As a rule, such take-up and feed-out arrangements are located in a chamber, which is separate from the coating chamber proper (DE 42 23 568 C1, DE 195 27 604 A1, CH 345 215). The drum with fresh and wound-up synthetic film as well as the drum with the coated synthetic film are conventionally introduced into the installation with a crane from above and also removed from the installation in the same way.

Arrangements for coating webs in a vacuum are also known, which comprise a transporting arrangement movable transversely to the running track (DE 37 26 113 A1). On this transporting arrangement are pivotably supported pairs of arms, whose pivot axis is disposed parallel to the running tracks, the free ends of the arm pairs being equipped with bearing eyes for the mounting of one bare winder and one take-up winder.

Furthermore is known an arrangement for replacing a winding core wound with winding material against an empty winding core without interrupting the supply of the winding material, which comprises an arrangement for the horizontal transport of the winding core (EP 0 093 301 B1). For the horizontal transport this arrangement has at least one loop, in whose horizontal movement the winding core takes part. The release of the winding core therein takes place in a first position and the acceptance of the winding core takes place in a second position of the winding core transported by the loop.

The invention addresses the problem of providing an arrangement for changing a spindle or a winding drum in a vacuum web coating installation, in which the spindle or the winding drum is not introduced into the coating installation from above.

This problem is solved according to the characteristics of patent claim 1.

Consequently, the invention relates to an arrangement for changing a winding drum in a take-up or feed-out chamber of a coating installation for web-form material. One such arrangement can be provided on each side of a coating chamber, the one arrangement serving as a take-up drum and the other arrangement as a feed-out drum. The arrangement has two tracks for receiving end bearings of a winding drum, the tracks being comprised of two parts, of which the one part is stationary and the other part is pivotable. The arrangement is located in a housing with a door. If the winding drum is to be replaced, the door is opened and the pivotable parts of the tracks are folded outwardly such that they project from the housing. Onto the projecting track parts a winding drum can now be placed, it can subsequently be slid inwardly and be arrested in place.

The advantage attained with the invention consists in particular therein that the film winders can be introduced laterally into the feed-out winding chamber of a web coating installation. Consequently, a mounting [sic: hall?] in which a web coating installation is located, does not need to have great structural height in order to include a hall crane. Spatial volumes of production halls involve investment issues, if the production installation is to be placed in clean rooms.

An embodiment example of the invention is shown in the drawing and will be described in the following in further detail. In the drawing depict:

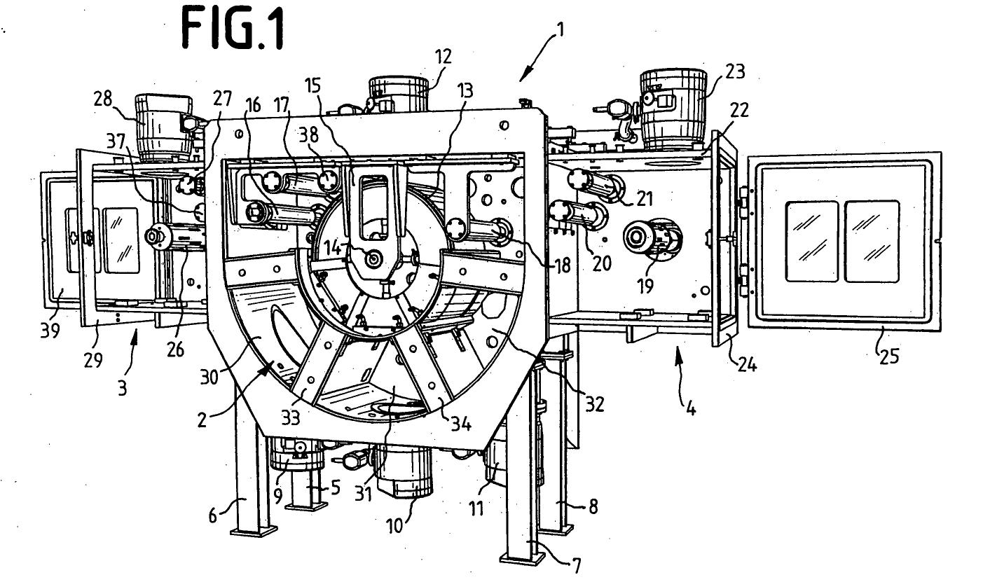

FIG. 1 a perspective view of a coating installation with a feed-out and a take-up arrangement;

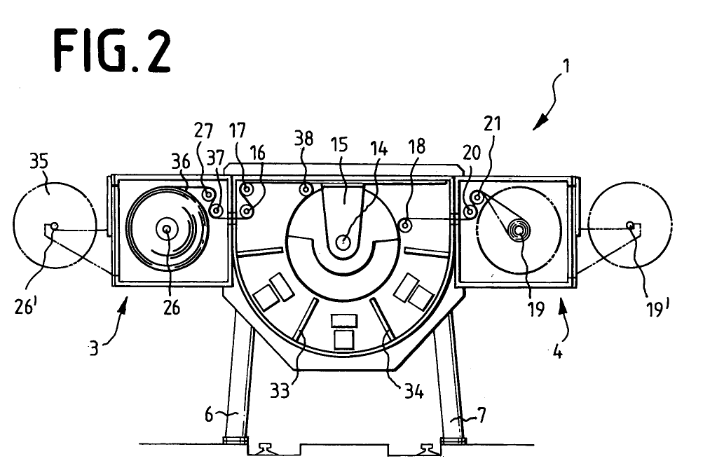

FIG. 2 a schematic representation of a coating installation, in which the film to be coated is transported from a feed-out station to a take-up station;

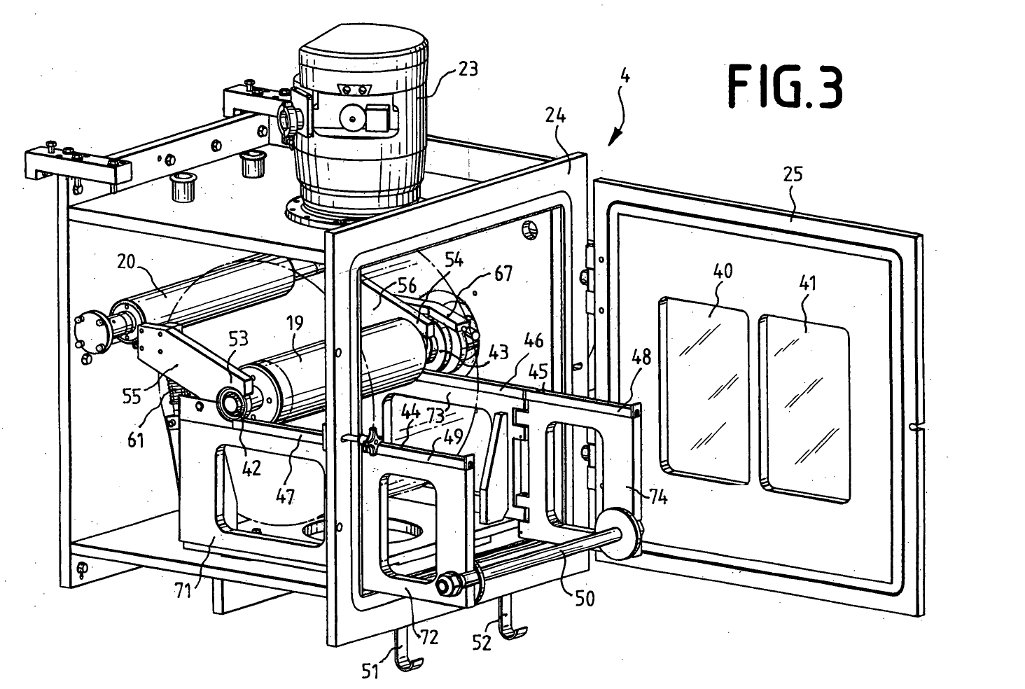

FIG. 3 a perspective view of a take-up station with the door open;

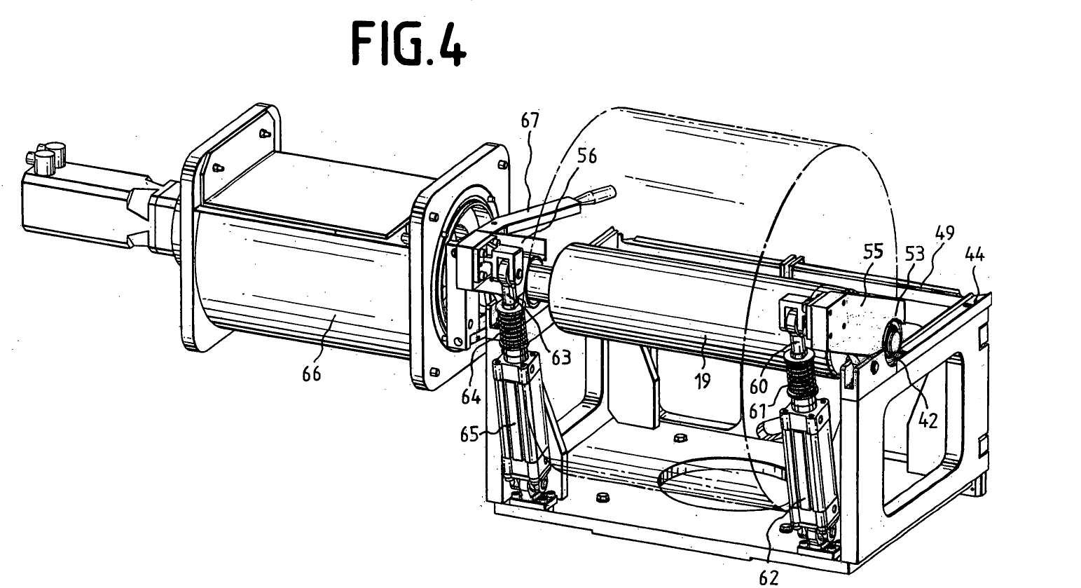

FIG. 4 a further perspective view of the take-up station with a driving unit for a winding drum;

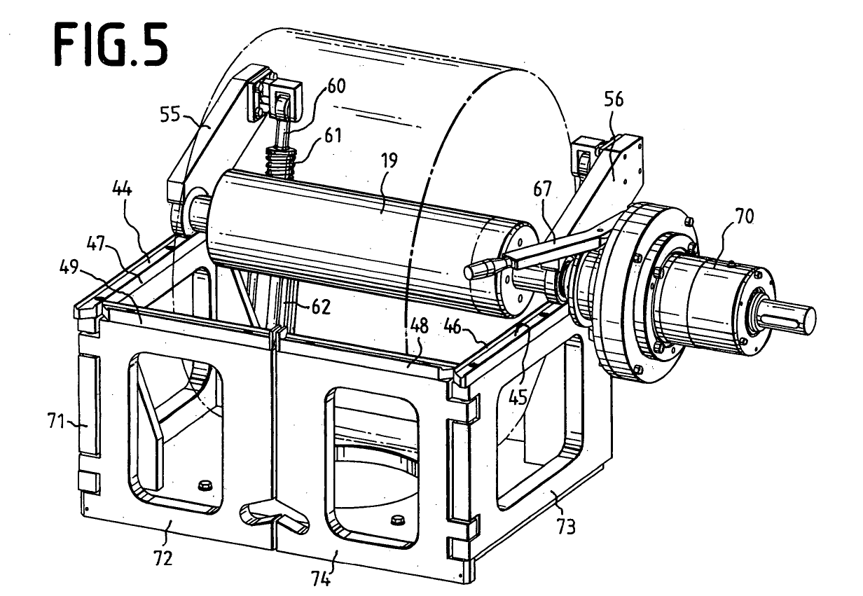

FIG. 5 a further perspective view of the take-up station with the tracks folded closed;

FIG. 1 shows an installation 1 for coating films, which comprises a coating chamber 2 as well as a feed-out chamber 3 and a take-up chamber 4.

The coating chamber 2 is supported on four columns 5 to 8 and includes pumps 9 to 12 with which the coating chamber 2 can be evacuated. A coating cylinder 13 is supported with its center axle 14 in a support 15. On the side of the coating cylinder 13 are guide rollers 16, 17, 18 for a web to be coated. The sputtering cathode for the coating of the film is not shown in the coating chamber 2. The take-up chamber 4 comprises a take-up cylinder 19 and two guide rollers 20, 21. On the top side 22 of the take-up chamber 4 is located a vacuum pump 23, with which the take-up chamber 4 can be evacuated. The lateral entrance 24 of the take-up chamber 4 can be closed with a door 25, which in FIG. 1 is shown in the open state. The side walls of chambers 2, 3, 4, facing the viewer, in which the rollers 16, 17, 18, 19, 20, 21, etc. are supported, are not depicted in FIG. 1.

The feed-out chamber 3 is structured analogously to the take-up chamber 4. It comprises a feed-out cylinder 26, guide rollers 27, 37 and a pump 28. The side entrance 29 can be closed by a door 39. The coating chamber 2 comprises several individual chambers 30 to 32, which are separated from one another by walls 33, 34.

FIG. 2 shows once again the installation 1 in a side view and in a fundamental representation. Again, the feed-out cylinder 26 and the take-up cylinder 19 as well as guide rollers 20, 21, 16, 17, 27, 37 and 38 can be seen.

A cylinder 35 fully wound with a film is moved from position 26′ into position 26. A film 36 runs over the guide rollers 27, 37, 16, 17, 38 to the underside of the coating cylinder 13, where it is coated. Hereupon the film 36 leaves the coating cylinder 13 and arrives via guide rollers 18, 20, 21 at the take-up cylinder 19. When the take-up cylinder 19 is wound fully with the film, it is removed from the take-up chamber 4 and brought into position 19′.

The feed-out chamber 3 and the take-up chamber 4 are disposed mirror symmetrically relative to the coating chamber 2, such that it is sufficient to describe in the following only one of these chambers in further detail.

FIG. 3 shows the opened take-up chamber 4. The door 25 is here provided with two glass windows 40, 41. The take-up cylinder 19 has at each of its ends one bearing 42, 43, guided by a track 44, 45 disposed on the top side of a support 71, 72 or 73, 74, respectively. The tracks 44, 45 are developed such that they can be folded together with the support 71, 72; 73, 74. They comprise a stationary part 46, 47 and a pivotable part 48, 49. In the depiction of FIG. 3 the pivotable parts 48, 49 are folded out and secured in position with a rod 50. The partial tracks 46, 48 are supported on supports 73, 74, which are also pivotable. The same applies to the partial tracks 47, 49, which are supported on supports 71, 72. By folding out the pivotable parts 48, 49, these project from the chamber 4, such that the winding core 19 can be readily brought into place or be removed.

During operation of the coating installation 1, i.e. when the door 25 is closed, the rod 50 is not required; in this case it rests in hooks 51, 52, which are attached beneath the take-up chamber 4.

The take-up cylinder 19 is arrested in its position depicted in FIG. 3, since the bearings 42, 43 are encompassed by one claw 53, 54 each. These claws 53, 54 form the end of an arm 55, 56, which can be actuated by a pneumatic cylinder 62, 65 (FIG. 4).

When introducing or removing the winding cylinder 19, the arms 55, 56 are raised by pneumatic cylinder 62, 65 (FIG. 4) against a force and therewith the bearings 42, 43 are released.

The winding cylinder 19 can now roll forward along tracks 46, 48; 47, 49 and be removed outside of chamber 4.

In corresponding manner subsequently a new, i.e. empty, winding drum is introduced into chamber 4 and secured tightly by claws 53, 54.

In FIG. 4 the arrangement according to FIG. 3 is again shown in perspective rear view. Evident are here the winding cylinder 19 with its bearing 42 supported in track 44. The pivotable part 49 of track 44 is pivoted inwardly by 90 degrees compared to the position shown in FIG. 3. The arm 55 with claw 53 is connected at its rear end with a piston 60, which through a spring 61 extends into a pneumatic cylinder 62. The arm 56 is correspondingly connected with its rear end with a piston 63, which extends through a spring 64 into a pneumatic cylinder 65. Springs 61, 64 effect the closing force of arms 55, 56. Cylinders 62, 65 must counteract this closing force in order for the claws 53, 54 to release the bearings 42, 43 for the removal or the placement of the cylinders 19, 26.

Onto the winding cylinder 19 is flanged a driving unit 66. In order to ensure the rotation of the winding cylinder 19, a coupling lever 67 is actuated, which connects the winding cylinder 19 with the driving unit 66 disposed on the outside.

FIG. 5 shows once again the arrangement of FIG. 4 in a position rotated by approximately 180 degrees. In this view the front parts 48, 49 of the tracks are folded inwardly. The driving unit 66 is removed in order for the driving coupling 70 to be visible. This driving coupling 70 is switchable by means of the lever 67.

1. Arrangement for changing a winding drum in a take-up or feed-out chamber of a coating installation for web-form material, characterized by two guide tracks (44, 45) for receiving bearings (42, 43) of a winding drum (19), each of the guide tracks (44, 45) being divided into two partial tracks (47, 49; 46, 48), of which in each instance one partial track (49, 48) is pivotable relative to the other partial track (47, 46).

2. Arrangement as claimed in claim 1, characterized in that the bearings (42, 43) are arrestable in a specific position on the guide tracks (44, 45).

3. Arrangement as claimed in claim 2, characterized in that for the arresting, pivot arms (55, 56) are provided, which have a recess, which encompass the bearing (42, 43).

4. Arrangement as claimed in claim 3, characterized in that the pivot arms (55, 56) are rotatable about an axis of rotation.

5. Arrangement as claimed in claim 1, characterized in that the winding drum (19) is connected via a coupling (70) with a driving unit (66).

6. Arrangement as claimed in claim 5, characterized in that the coupling (70) is switchable by means of a lever (67).

7. Arrangement as claimed in claim 3, characterized in that pneumatic cylinders (62, 65) are provided for opening the pivot arms (55, 56).

8. Arrangement as claimed in claim 3, characterized in that springs (61, 64) are provided for closing the pivot arms (55, 56).

9. Arrangement as claimed in claim 1, characterized in that the pivotable partial tracks (48, 49) are pivotable by 90 degrees relative to the other partial tracks (47, 46).

10. Arrangement as claimed in claim 1, characterized in that the pivotable partial tracks (48, 49) are supported on pivotable supports (72, 74), which have a recess on one side.

11. Arrangement as claimed in claim 1 and claim 10, characterized in that a rod (50) is provided, which, when the partial tracks (48, 49) are pivoted away from each other, is inserted in the recesses of the supports (72, 74) and therewith acts as a spacer.

12. Arrangement as claimed in claim 1, characterized in that it is provided on both sides of a coating chamber (2).

13. Arrangement as claimed in claim 1, characterized in that the take-up or feed-out chamber (3, 4) is provided with a door (25) and, when the door (25) is closed, the folded-together tracks (44, 45) extend close up to this door (25).
